(19) United States
(12) Patent Application Publication
(10) Pub. No.: US 2014/0226502 A1
(43) Pub. Date: Aug. 14, 2014

(54) COEXISTENCE OF CELLULAR AND CONNECTIVITY NETWORKS WITH GLOBAL NAVIGATION SATELLITE SYSTEMS

(71) Applicant: QUALCOMM INCORPORATED, San Diego, CA (US)

(72) Inventors: Firouz Behnamfar, San Jose, CA (US); Paul Husted, San Jose, CA (US); Tim P. Pals, San Diego, CA (US); Emilija M. Simic, San Diego, CA (US)

(73) Assignee: QUALCOMM Incorporated, San Diego, CA (US)

(21) Appl. No.: 13/766,633

(22) Filed: Feb. 13, 2013

(51) Int. Cl. H04W 72/10

(52) U.S. Cl. CPC H04W 72/10
USPC 370/252; 370/329; 370/336

(57) ABSTRACT

A wireless device includes a first circuit to transmit wireless signals, a second circuit to receive satellite signals, and a processor. The processor is to selectively adjust a transmission rate of the wireless signals in response to a comparison between a first priority value assigned to the wireless signals and a second priority value assigned to the satellite signals. The processor may also monitor one or more operational parameters associated with the wireless signals, and in response thereto dynamically adjust one or both of the first and second priority values.

### TECHNICAL FIELD

The present embodiments relate generally to wireless communications, and specifically to the co-existence of multiple wireless transceivers and a satellite receiver on a communication device.

### BACKGROUND OF RELATED ART

Many wireless devices such as smartphones and tablet computers are capable of wireless communication with other devices using wireless local area network (WLAN) signals, BLUETOOTH® (BT or Bluetooth) signals, and cellular signals such as long term evolution (LTE) signals. In addition, many of these wireless devices are also capable of receiving various global navigation satellite system (GNSS) signals for positioning and/or navigation purposes. Unfortunately, the concurrent transmission of WLAN/BT signals and cellular signals may impair the ability to receive GNSS signals.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A device and method of operation are disclosed that may minimize interference of received satellite signals resulting from the concurrent transmission of multiple wireless signals. In accordance with the present embodiments, the transmission rate and/or power level of wireless signals (e.g., Wi-Fi® signals and/or BT signals) may be adjusted in response to a comparison between a first priority value assigned to the wireless signals and a second priority value assigned to the satellite signals, whereby the comparison may indicate the importance of receiving the satellite signals relative to the transmission of the wireless signals. In this manner, when the device determines that reception of the satellite signals may be more important than transmission of the wireless signals, the device may reduce the transmission rate and/or power level of the wireless signals to reduce interference with the satellite signals.

For some embodiments, the device may dynamically adjust the first priority value and/or the second priority value in response to one or more operational parameters that may affect the importance of transmitting Wi-Fi signals (and/or BT signals) relative to the importance of receiving the satellite signals. These operational parameters may include, for example, information indicating whether the device is in motion, whether the device is currently using a satellite-based positioning or navigation application and/or a WLAN-based positioning or navigation application, the signal strength of the satellite signals, a length of time since the last WLAN transmission, a quality of service (QoS) parameter associated with WLAN traffic, and/or WLAN throughput. In this manner, the device may dynamically adjust the transmission rate and/or power level of the Wi-Fi signals in response to changing operating conditions, user activity, device location, and/or device movement to minimize interference with the satellite signals during periods of time that the reception of satellite signals is of a higher priority than the transmission of Wi-Fi signals.

In addition, for some embodiments, the device may dynamically adjust the first priority value and/or the second priority value in response to one or more weighting values provided by a user of the device.

### BRIEF DESCRIPTION OF THE DRAWINGS

The present embodiments are illustrated by way of example and are not intended to be limited by the figures of the accompanying drawings, where:

FIG. 1 is a graph depicting generation of intermodulation products associated with the concurrent transmission of Wi-Fi signals and LTE signals, relative to the frequency of received satellite signals.

FIG. 2 is a functional block diagram of a communication device in accordance with some embodiments.

FIG. 3 is a block diagram of a WLAN controller in accordance with some embodiments.

FIG. 4 depicts a number of operational parameters provided to the processor of FIG. 2 in accordance with at least some embodiments.

FIG. 5 is an illustrative state machine to implement an exemplary operation of the device of FIG. 2 in accordance with at least some embodiments.

FIG. 6 is a flow chart depicting an exemplary operation of the device of FIG. 2 in accordance with at least some embodiments.

Like reference numerals refer to corresponding parts throughout the drawing figures.

### DETAILED DESCRIPTION

The present embodiments are discussed below in the context of concurrently transmitting Wi-Fi signals and LTE signals while receiving satellite signals for simplicity only. It is to be understood that the present embodiments are equally applicable for concurrently transmitting multiple signals of other various wireless standards or protocols while receiving other signals. As used herein, the terms WLAN and Wi-Fi can include communications governed by the IEEE 802.11 family of standards, HiperLAN (a set of wireless standards, comparable to the IEEE 802.11 standards, used primarily in Europe), and other technologies having relatively short radio propagation range, and the term Bluetooth can include communications governed by the IEEE 802.15 family of standards. Further, as used herein, the term LTE can include cellular communications governed by any suitable cellular standards or protocols. Thus, although described herein with respect to LTE signals, the present embodiments are equally applicable to other types of cellular signals including, for example, GSM signals, CDMA signals, and so on.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The present embodiments are not to be construed as limited to specific examples described herein but rather to include within their scopes all embodiments defined by the appended claims.

Some embodiments are described herein as adjusting the transmission rate and/or power level of one or more wireless signals. As used herein, the term “transmission rate” may refer to an amount of data transmitted via wireless signals from a device over a given period of time, for example, such that decreasing the transmission rate may reduce the wireless signals' interference upon the reception of satellite signals. Thus, for one or more embodiments, the transmission rate may be decreased by not transmitting data during selected intervals (e.g., thereby reducing the transmission duty cycle) and/or by reducing the number of data frames or packets transmitted during selected intervals. For one or more other embodiments, the transmission rate may be decreased by reducing the physical layer (PHY) rate of the device, which in turn may reduce the wireless signals' interference upon the reception of satellite signals by decreasing the transmission power of the wireless signals.

In addition, the term “satellite-based positioning application” may refer to any application that provides positioning and/or navigation information based, at least in part, upon received satellite signals. Similarly, the term “WLAN-based positioning application” may refer to any application that provides positioning and/or navigation information based, at least in part, upon received wireless signals such as Wi-Fi signals, BT signals, and/or LTE signals.

When wireless devices such as smartphones and tablet computers concurrently transmit Wi-Fi/Bluetooth signals and LTE signals while receiving satellite signals, the generation and/or transmission of the Wi-Fi signals and LTE signals may create intermodulation products that interfere with the reception of satellite signals. For example, if first and second input signals having different fundamental frequencies are applied to a non-linear circuit (e.g., a power amplifier), then the output signal of the non-linear circuit may contain not only the first and second input signals but also intermodulation (IM) products. These IM products may include component signals having frequencies not only at the harmonic frequencies of the first and second input signals but also at the sum and difference frequencies of the first and second input signals (as well as the harmonics of the sum and difference frequencies). In addition to creating undesirable out-of-band spectral components, these IM products may interfere with the reception of other signals having frequencies near the IM products' frequencies.

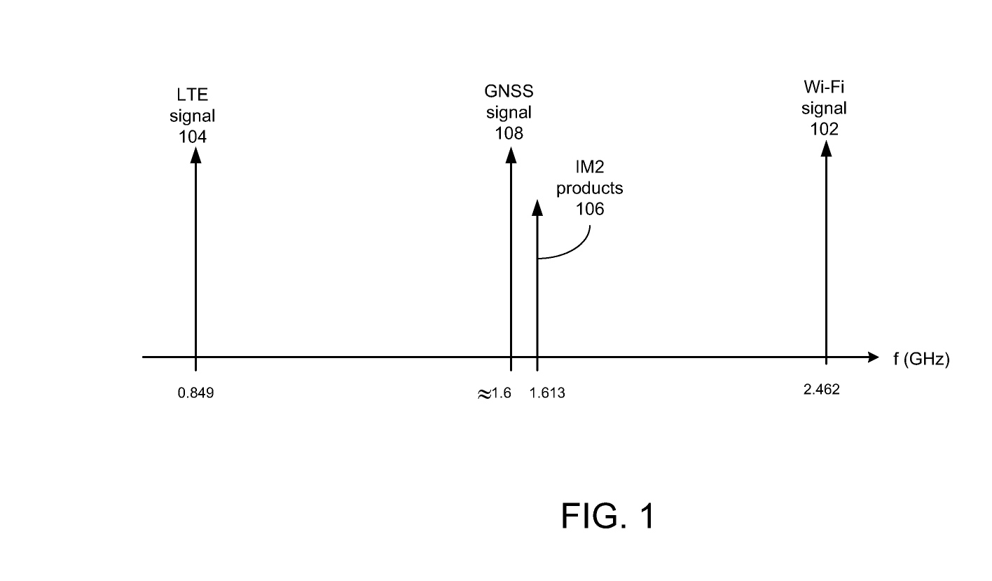

More specifically, referring to FIG. 1, the concurrent generation and/or transmission of a Wi-Fi signal 102 having a center frequency f1=2.462 GHz (e.g., 802.11b channel 11) and an LTE signal 104 having a center frequency f2=849 MHz (e.g., LTE band 5) may create second-order intermodulation (IM2) products 106 at a difference frequency f3=f1−f2=1.613 GHz. If a GNSS signal 108 has a frequency f4≈1.6 GHz (e.g., such as a GLONASS channel 6 signal having a carrier frequency of 1.605375 GHz), then the IM2 products 106 may interfere with reception of the GNSS signal 108. Thus, for the example depicted in FIG. 1, the concurrent generation and/or transmission of Wi-Fi signals 102 and LTE signals 104 from a device may severely limit the device's ability to receive the GNSS signals 108, which in turn may degrade performance of various location-based services (e.g., positioning and/or navigation services) dependent upon reception of the GNSS signals 108.

In accordance with the present embodiments, a communication device and method of operation are disclosed that may reduce the interference of satellite signals (e.g., GNSS signals) caused by IM products by selectively adjusting the transmission rate and/or power level of wireless signals from the device in response to the relative priorities of transmitting the wireless signals and receiving the satellite signals. As mentioned above, priority values may be: assigned to the transmission of the wireless signals and to the reception of the satellite signals; dynamically adjusted in response to a number of operational parameters; and compared with each other to determine whether the transmission rate and/or power level of the wireless signals is to be adjusted to reduce interference with the satellite signals. The operational parameters may include, for example, information indicating whether the device is in motion, whether the device is currently using a satellite-based positioning application and/or a WLAN-based positioning application, the signal strength of the satellite signals, a length of time since the last WLAN transmission, a quality of service (QoS) parameter associated with WLAN traffic, WLAN throughput, and/or other factors that may be useful in determining whether WLAN transmissions may be throttled, delayed or terminated to facilitate reception of satellite signals.

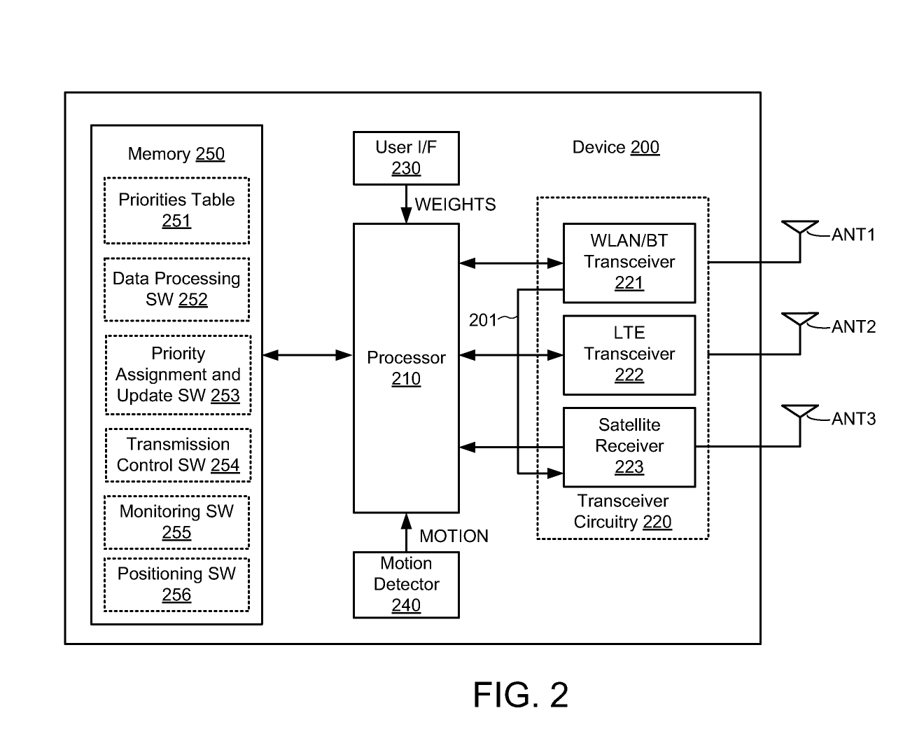

FIG. 2 shows a communication device 200 in accordance with some embodiments. Device 200 may be any suitable device that is capable of transmitting one or more wireless signals (e.g., Wi-Fi signals, Bluetooth signals, LTE signals, and so on) while receiving one or more satellite signals (e.g., GNSS signals). Thus, for at least some embodiments, device 200 may be a cellular phone, a tablet computer, a personal digital assistant (PDA), a laptop computer, an in-vehicle navigation and communication system, and the like. For at least one embodiment, device 200 may use Wi-Fi signals to exchange data with a network (e.g., the Internet, a local area network (LAN), a wide area network (WAN), a WLAN, and/or a virtual private network (VPN)), may use Bluetooth signals to exchange data with local BT-enabled devices (e.g., headsets, printers, scanners), may use cellular signals (e.g., LTE signals, GSM signals, CDMA signals, and so on) to exchange data with other wireless devices via a suitable cellular network, and may use satellite signals (e.g., Global Positioning System (GPS) signals, Global Navigation Satellite System (GLONASS) signals, and so on) to facilitate positioning services, navigation services, and/or various location-based services.

Device 200 is shown to include a processor 210, transceiver circuitry 220, a user interface 230, a motion detector 240, a memory 250, and three antennas ANT1-ANT3. Processor 210, which may include well-known elements such as processors and memory elements, may perform general data generation and processing functions for the device 200. Transceiver circuitry 220, which is coupled to antennas ANT1-ANT3 and to processor 210, is shown in FIG. 2 as including a WLAN/BT transceiver 221, LTE transceiver 222, and a satellite receiver 223. Although not shown in FIG. 2 for simplicity, transceiver circuitry 220 may also include other suitable transceivers and/or associated circuits (e.g., power amplifiers, filters, up-samplers, down-samplers, analog-to-digital converters, digital-to-analog converters, mixers, and so on) to facilitate the transmission and reception of various wireless signals.

Satellite receiver 223, which is coupled to processor 210 and to third antenna ANT3, facilitates and controls the reception of satellite signals. WLAN/BT transceiver 221, which is coupled to processor 210, facilitates and controls the transmission and reception of Wi-Fi signals and Bluetooth signals. LTE transceiver 222, which is coupled to processor 210, facilitates and controls the transmission and reception of LTE signals. Although an integrated WLAN/BT transceiver 221 is depicted in FIG. 2 for simplicity, for other embodiments, the WLAN and BT transceiver portions may be implemented separately.

For at least some embodiments, satellite receiver 223 may receive a blanking signal 201 from WLAN/BT transceiver 221. The blanking signal 201 may correspond to an enable signal(s) associated with one or more power amplifiers (not shown for simplicity) within WLAN/BT transceiver 221. For some embodiments, the blanking signal 201 may be asserted when the transmission duty cycle of the Wi-Fi signals is less than a predetermined threshold value. In response to the asserted blanking signal 201, the satellite receiver 223 may selectively halt reception of the satellite signals and/or halt processing of received satellite signals (e.g., by “zeroing” inputs to one or more correlators (not shown for simplicity) provided within satellite receiver 223). For at least one embodiment, the blanking signal 201 may be generated by WLAN/BT transceiver 221 and/or processed by satellite receiver 223 in a manner similar to that described in commonly-owned U.S. Pat. No. 6,107,960, the entirety of which is incorporated by reference herein.

For other embodiments, the blanking signal 201 may be asserted when a transmission duration of the Wi-Fi signals is less than a predetermined time value (e.g., 10 ms). For example, if a time period associated with receiving each bit of a satellite signal is 20 ms, and if the Wi-Fi signals are to be transmitted for approximately 10 ms or more, then it may not be desirable to blank the satellite signals because of an increased “time-to-fix” resulting from a loss of satellite data. On the other hand, if the Wi-Fi signals are to be transmitted for less than approximately 10 ms, then it may be desirable to blank the satellite signals (e.g., because blanking may increase the satellite receiver signal-to-noise ratio). In this manner, the received satellite signals may be filtered (e.g., by “zeroing” inputs to one or more satellite signal correlators) or even ignored (e.g., by not integrating a portion of the received satellite data) for a given duration so that IM products associated with the concurrent transmission of Wi-Fi signals and LTE signals (or other cellular signals) do not adversely affect the integrity of the satellite signals.

WLAN/BT transceiver 221 and LTE transceiver 222 may use antennas ANT1-ANT2 for transmission and reception operations. For at least one embodiment, WLAN/BT transceiver 221 may use antenna ANT1 and LTE transceiver 222 may use antenna ANT2. For at least another embodiment, one or both of antennas ANT1-ANT2 may be shared by WLAN/BT transceiver 221 and LTE transceiver 222. In addition, for some embodiments, satellite receiver 223 may share one or more of antennas ANT1-ANT3 with WLAN/BT transceiver 221 and/or LTE transceiver 222. Further, although depicted in the exemplary embodiment of FIG. 2 as including only three antennas ANT1-ANT3, device 200 may include more than three antennas, and may be configured to implement multiple-input multiple-output (MIMO) signaling techniques.

The various components (not shown for simplicity) within processor 210, WLAN/BT transceiver 221, LTE transceiver 222, and/or satellite receiver 223 may be implemented in a variety of ways including, for example, using analog logic, digital logic, processors (e.g., CPUs, DSPs, microcontrollers, and so on), application specific integrated circuits (ASICs), field programmable gate arrays (FPGAs), or any combination of the above. Further, as mentioned above, WLAN/BT transceiver 221 and LTE transceiver 222 may include one or more power amplifiers, filters, and other suitable circuits to facilitate the transmission and reception of various suitable wireless signals. For at least one embodiment, the concurrent application of Wi-Fi signals, Bluetooth signals, and/or LTE signals to a power amplifier (not shown for simplicity) within transceiver circuitry 220 may create IM products that interfere with the reception of satellite signals by satellite receiver 223. Note that such IM products may also be generated within satellite receiver 223.

User interface 230, which is coupled to processor 210, may be any suitable interface (e.g., keyboard, keypad, touchpad, touch screen, and so on) that can receive one or more input values or parameters provided by a user of device 200. For example, a user of device 200 may enter one or more weighing values via user interface 230 that may be used as weights for priorities assigned to the transmission of wireless signals (e.g., Wi-Fi signals, Bluetooth signals, and/or cellular signals) and/or to the reception of satellite signals.

Motion detector 240, which is coupled to processor 210, may be any suitable circuit or sensor that can detect whether device 200 is in motion or is stationary. For at least one embodiment, motion detector 240 may assert a motion indicator signal (MOTION) to a first logic state if device 200 is in motion, and motion detector 240 may de-assert the signal MOTION to a second logic state if device 200 is not in motion.

Memory 250 includes a priorities table 251 that stores one or more priority values and/or one or more weighting values that may be used to determine the priority of transmitting wireless signals (e.g., Wi-Fi, Bluetooth, and LTE signals) relative to the priority of receiving satellite signals. As described in greater detail below, the relative priorities of transmitting wireless signals and receiving satellite signals may be used to selectively adjust the transmission rates of the wireless signals, for example, to reduce the interference of the satellite signals caused by IM products created during concurrent transmission of multiple wireless signals. For some embodiments, a first priority value (PV1) is assigned to the transmission of wireless signals and stored in a first location of priorities table 251, and a second priority value (PV2) is assigned to the reception of satellite signals and stored in a second location of priorities table 251.

In addition, priorities table 251 may also store a number of operational parameters that may be used to dynamically update or adjust the priority values assigned to the transmission of wireless signals and/or to the reception of satellite signals. For example, for at least one embodiment, the operational parameters may indicate whether the device is in motion, whether the device is currently using a satellite-based positioning application and/or a WLAN-based positioning application, the signal strength of the satellite signals, a length of time since the last WLAN transmission, a QoS parameter associated with WLAN traffic, and/or WLAN throughput information.

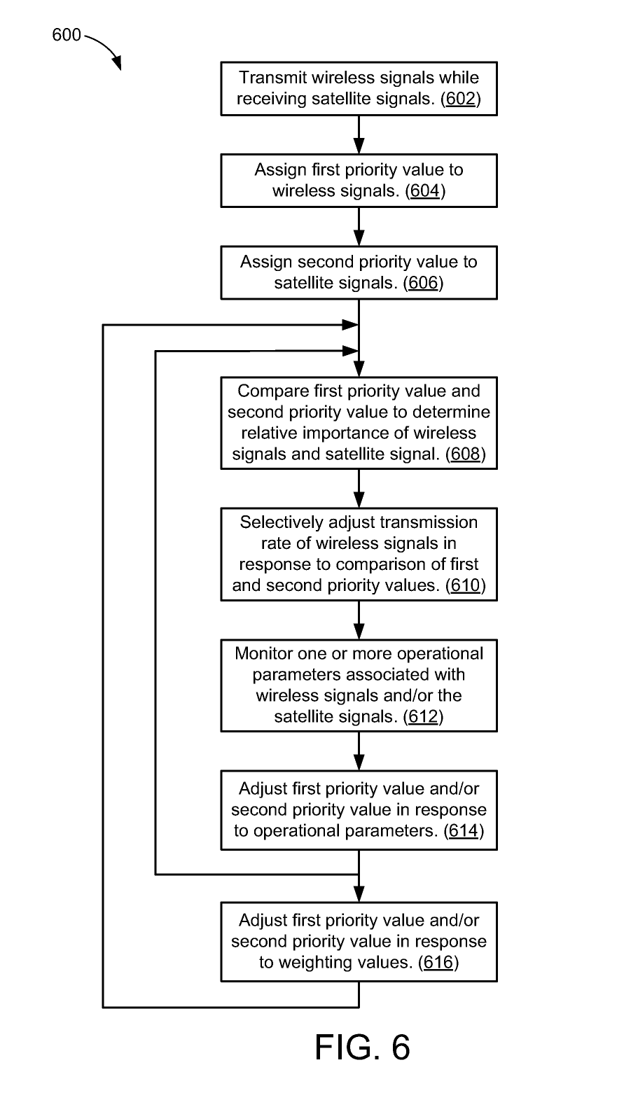

Memory 250 may also include a non-transitory computer-readable storage medium (e.g., one or more nonvolatile memory elements, such as EPROM, EEPROM, Flash memory, a hard drive, and so on) that can store the following software modules:
a data processing software module 252 to be used to facilitate the creation and/or processing of various signals provided to and/or received from transceiver circuitry 220 (e.g., as described for operation 602 of FIG. 6);
a priority assignment and update software module 253 to be used to assign a first priority value (PV1) to the transmission of Wi-Fi signals (and/or the LTE signals and Bluetooth signals), to assign a second priority value (PV2) to the reception of satellite signals, and/or to dynamically update the first priority value and/or the second priority value in response to one or more operational parameters (e.g., as described for operations 604, 606, 614, and/or 616 of FIG. 6);
a transmission control software module 254 to be used to selectively adjust the transmission rate and/or power level of the Wi-Fi signals (and/or the LTE signals and Bluetooth signals) in response to a comparison of the first priority value and the second priority value (e.g., as described for operation 610 of FIG. 6);
a monitoring software module 255 to be used to monitor a number of operational parameters associated with the wireless signals and/or satellite signals (e.g., as described for operation 612 of FIG. 6); and
a positioning software module 256 to be used to implement one or more location-based services (e.g., to determine the position of device 200, to provide navigation services, to deliver location-based information, and so on) for a user of device 200.
   Each software module includes instructions that, when executed by processor 210, cause device 200 to perform the corresponding functions. The non-transitory computer-readable storage medium of memory 250 thus includes instructions for performing all or a portion of the operations of method 600 (FIG. 6). While illustrated as software modules 251-256, it should be understood that each may be embodied in software (which may include firmware), hardware (e.g., dedicated circuitry to provide signals to the processor 210) or a combination of both.

Processor 210, which is coupled to transceiver circuitry 220, user interface 230, motion detector 240, and memory 250, may be any suitable processor capable of executing scripts or instructions of one or more software programs stored in device 200 (e.g., within memory 250).

When device 200 is communicating with one or more other devices, processor 210 may generate data to be transmitted as Wi-Fi signals, Bluetooth signals, and/or LTE signals to the other device(s) via one or more of antennas ANT1-ANT3, and may receive Wi-Fi signals, Bluetooth signals, LTE signals, and/or satellite signals from the other device(s) via one or more of antennas ANT1-ANT3. During such communications, processor 210 may assign the first priority value (PV1) to the transmission of Wi-Fi signals and may assign the second priority value (PV2) to the reception of satellite signals. For some embodiments, the first and second priority values may be weighted in response to a number of weighting values (e.g., provided by a user via user interface 230).

Once priority values PV1 and PV2 are assigned to the transmission of Wi-Fi signals and to the reception of satellite signals, respectively, processor 210 may compare the priority values PV1 and PV2 with each other (or with a number of priority threshold values) to determine the priority or importance of transmitting the Wi-Fi signals relative to the priority or importance of receiving the satellite signals. Thereafter, processor 210 may adjust the transmission rate and/or the power level of the Wi-Fi signals in response to the relative priorities of the Wi-Fi signals and the satellite signals. In this manner, when reception of the satellite signals is deemed to be more important than transmission of the Wi-Fi signals, processor 210 may reduce the transmission rate and/or power level of the Wi-Fi signals (or terminate transmission of the Wi-Fi signals) to reduce interference with the satellite signals. Conversely, when reception of the satellite signals is deemed to be less important than transmission of the Wi-Fi signals, processor 210 may increase the transmission rate and/or power level of the Wi-Fi signals (or otherwise not decrease the transmission rate or power level) to facilitate operations associated with the transmission of Wi-Fi signals.

In addition, processor 210 may dynamically adjust the first priority value PV1 and/or the second priority value PV2 in response to one or more operational parameters that may affect the importance of transmitting Wi-Fi signals (and/or Bluetooth signals) relative to the importance of receiving the satellite signals. As mentioned above, these operational parameters may include, for example, information indicating whether the device is in motion, whether the device is currently using a satellite-based positioning application and/or a WLAN-based positioning application, the signal strength of the satellite signals, a length of time since the last WLAN transmission, a QoS parameter associated with WLAN traffic, and/or WLAN throughput. In this manner, processor 210 may dynamically adjust the transmission rate and/or power level of the Wi-Fi signals in response to changing operating conditions, user activity, device location or movement, and/or other factors to minimize interference with the satellite signals (e.g., caused by IM2 products resulting from the concurrent transmission of Wi-Fi signals, Bluetooth signals, and/or LTE signals) during periods of time that the reception of satellite signals is of a higher priority than the transmission of Wi-Fi signals. As a result, the transmission rate and/or power level of the Wi-Fi signals may be adjusted in response to dynamic changes in the relative importance of transmitting Wi-Fi signals (e.g., relative to the importance of receiving satellite signals). For one example, if device 200 is currently executing a WLAN-based positioning program, then processor 210 may increase the priority of transmitting Wi-Fi signals relative to the priority of receiving satellite signals. For another example, if device 200 is not currently in motion, then processor 210 may increase the priority of transmitting Wi-Fi signals relative to the priority of receiving satellite signals (e.g., because stationary devices may not need to continue receiving satellite signals).

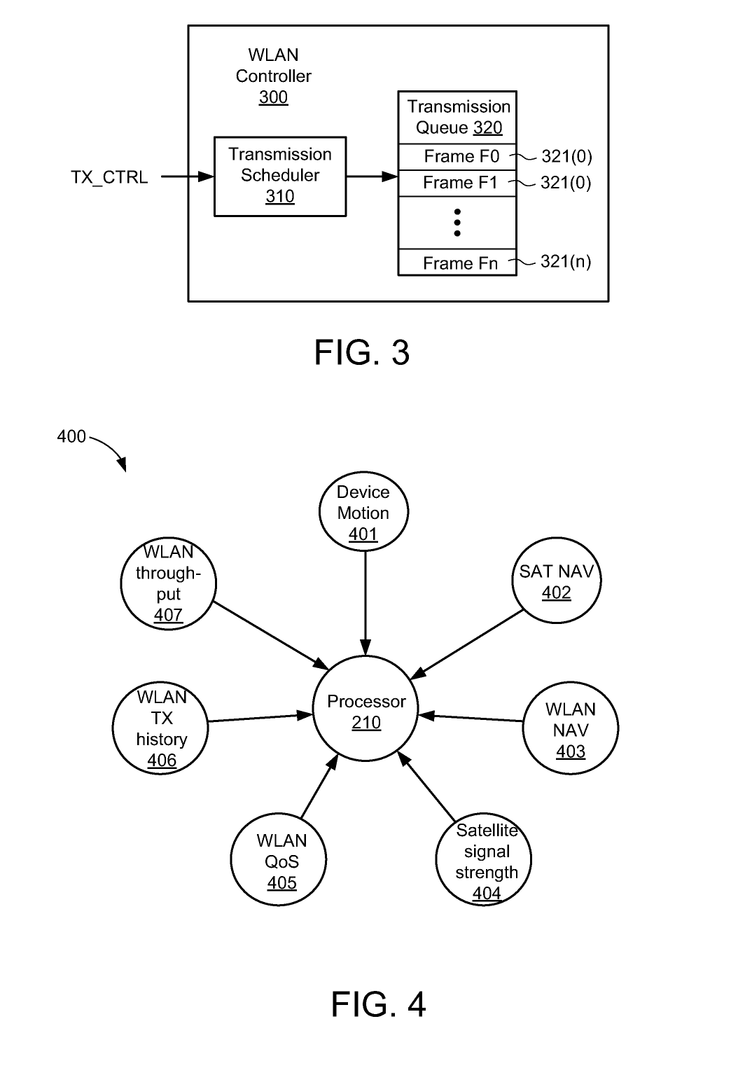

FIG. 3 shows a portion of a WLAN controller 300 in accordance with some embodiments. WLAN controller 300, which may be included as part of or otherwise associated with WLAN/BT transceiver 221, includes a transmission scheduler 310 and a transmission queue 320. Transmission scheduler 310, which is coupled to and controls operation of transmission queue 320, includes an input to receive a transmission control signal (TX_CTRL) from processor 210 of FIG. 2. Transmission queue 320 includes a plurality of storage locations 321(0)-321(n) for storing a plurality of frames (frames F0-Fn) to be transmitted according to a suitable WLAN or Bluetooth protocol via one or more of antennas ANT1-ANT2. In response to the TX_CTRL signal, transmission scheduler 310 may instruct transmission queue 320 to adjust the transmission rate of the Wi-Fi signals by (i) dynamically allocating a number of transmission slots for frames F0-Fn for a given time period, (ii) by adjusting the transmission schedule of frames F0-Fn (e.g., by increasing or decreasing a time interval between transmission of successive frames F0-Fn), and/or (iii) by terminating de-queuing of frames F0-Fn. In addition, or alternatively for other embodiments, WLAN controller 300 may selectively adjust the transmission power level of the Wi-Fi signals and/or Bluetooth signals in response to the TX_CTRL signal.

Thus, in accordance with some present embodiments, the transmission rate of the Wi-Fi and/or Bluetooth signals may be adjusted by allocating different blocks of time for the transmission of Wi-Fi and/or Bluetooth signals. For at least one embodiment, the unit of time allocated for each transmission slot may be fixed, and the number of transmission slots allocated to the Wi-Fi signals and/or Bluetooth signals may be adjusted according to the relative priorities of the wireless signals and satellite signals.

For some embodiments, WLAN controller 300 may provide one or more signals to processor 210 and/or satellite receiver 223 indicating whether WLAN controller is adjusting the transmission rate and/or power level of the Wi-Fi signals. In addition, for some embodiments, WLAN controller 300 may receive one or more signals from satellite receiver 223 indicative of the signal strength of the satellite signals, and may be configured to selectively adjust the transmission rate and/or power level of the Wi-Fi signals in response to the signals provided by satellite receiver 223.

FIG. 4 is a diagram 400 depicting a number of operational parameters that may be provided to processor 210 and/or used by processor 210 to dynamically update or adjust the first priority value PV1 and/or the second priority value PV2 in accordance with at least some embodiments. For the exemplary embodiment of FIG. 4, processor 210 may receive information 401 indicating whether device 200 is in motion, information 402 indicating whether device 200 is currently using a satellite-based positioning application, information 403 indicating whether device 200 is currently using a WLAN-based positioning application, information 404 indicating the signal strength of the satellite signals, information 405 indicating a QoS parameter indicating a WLAN traffic type, information 406 indicating a length of time since the last WLAN transmission, and/or information 407 indicative of WLAN throughput. For some embodiments, processor 210 may consider any number (e.g., and thus any combination) of operational parameters associated with information 401-407 when updating or adjusting the first priority value PV1 and/or the second priority value PV2. While FIG. 4 illustrates processor 210 receiving all information 401-407, it should be understood that other combinations of information may be received, such as any subset of information 401-407 or information not illustrated in the Figure.

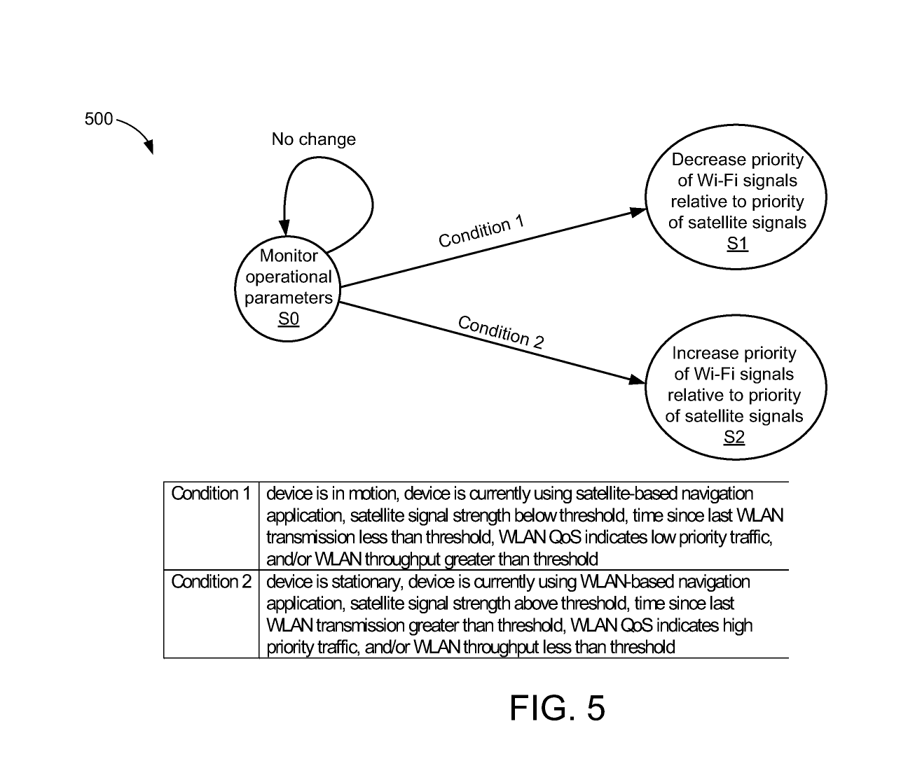

FIG. 5 shows an illustrative state machine 500 that, in accordance with at least some embodiments, may be implemented by processor 210 to dynamically adjust the priority values associated with the transmission of wireless signals and the reception of satellite signals by device 200. State machine 500 is initially in state 0 (SO), during which processor 210 may monitor one or more of the above-described operational parameters for changes in the device's operating conditions. If no change in the device's operational parameters is detected, then state machine remains in SO. If processor 210 detects a first condition corresponding to information indicating that the device 200 is in motion, that device 200 is currently using a satellite-based positioning application, that the satellite signal strength is below a signal strength threshold value, that the time since a last WLAN transmission is less than a WLAN transmission threshold time value, that the WLAN traffic is low priority traffic (e.g., associated with a “best effort” or other similar QoS priority), and/or that the WLAN throughput is greater than a WLAN throughput threshold value, then state machine 500 may transition to state 1 (S1). When state machine 500 is in S1, processor 210 may decrease the priority value PV1 of Wi-Fi signals relative to the priority value PV2 of the satellite signals (or increase the priority value PV2 of the satellite signals relative to the priority value PV1 of the Wi-Fi signals). In response thereto, the transmission rate and/or power level of the Wi-Fi signals may be decreased to reduce interference with the satellite signals.

Conversely, if processor 210 detects a second condition corresponding to information indicating that the device 200 is stationary, that device 200 is currently using a WLAN-based positioning application (or alternatively not using a satellite-based positioning application), that the satellite signal strength is at or above the signal strength threshold value, that the time since the last WLAN transmission is greater than or equal to the WLAN transmission threshold time value, that the WLAN traffic is high priority traffic (e.g., associated with a “guaranteed bandwidth” or other similar QoS priority), and/or that the WLAN throughput is less than or equal to the WLAN throughput threshold value, then state machine 500 may transition to state 2 (S2). When state machine 500 is in S2, processor 210 may increase the priority value PV1 of Wi-Fi signals relative to the priority value PV2 of the satellite signals (or decrease the priority value PV2 of the satellite signals relative to the priority value PV1 of the Wi-Fi signals). In response thereto, the transmission rate and/or power level of the Wi-Fi signals may be increased or maintained at the current transmission rate or power level).

Further, for at least one embodiment, if processor 210 determines that the satellite signal strength remains below a minimum signal strength threshold value for more than a predetermined duration (e.g., which may indicate that device 200 is indoors and therefore not in a position to receive the satellite signals), then state machine 500 may transition to state 2 (S2). In this manner, if the device 200 has been indoors for more than the predetermined duration (e.g., a user of device 200 is shopping in an indoor or underground shopping mall), then processor 210 may increase the priority of Wi-Fi signals relative to the satellite signals, for example, to increase the performance of WLAN-based positioning and/or navigation services.

FIG. 6 is a flow chart depicting an exemplary operation 600 of the device 200 of FIG. 2 in accordance with at least some embodiments. Initially, device 200 may be transmitting one or more wireless signals (e.g., Wi-Fi signals, Bluetooth signals, and/or LTE signals) while receiving satellite signals (602). As described above, concurrently transmitting wireless signals (e.g., Wi-Fi signals and/or Bluetooth signals) and cellular signals (e.g., LTE signals) may create intermodulation products that interfere with the reception of satellite signals. For example, referring also to FIG. 1, the concurrent transmission of Wi-Fi signal 102 having a center frequency f1=2.462 GHz (e.g., 802.11b channel 11) and LTE signal 104 having a center frequency f2=849 MHz (e.g., LTE band 5) may create second-order intermodulation (IM2) products 106 at a difference frequency f3=f1−f2=1.613 GHz. Thus, during reception of GNSS signal 108 having a frequency f4≈1.6 GHz, the IM2 products 106 may interfere with GNSS signal 108. This interference may limit device 200's ability to receive GNSS signals 108, which in turn may degrade performance of various location-based services (e.g., positioning services) dependent upon reception of the GNSS signals 108.

Referring again to FIG. 6, processor 210 may assign a first priority value PV1 to the wireless signals (604), and may assign a second priority value PV2 to the satellite signals (606). Then, processor 210 may compare the first priority value PV1 with the second priority value PV2 to determine the importance of transmitting the wireless signals relative to the importance of receiving the satellite signals (608). Next, processor 210 may selectively adjust the transmission rate (and/or the power level) of the wireless signals in response to the comparison of the first and second priority values (610).

For some embodiments, if the second priority value PV2 is greater than the first priority value PV1 (which may indicate that reception of the satellite signals is currently more important than transmission of the wireless signals), then processor 210 may decrease the transmission rate and/or the power level of the wireless signals. In this manner, processor 210 may reduce the impact of the IM products' interference with the received satellite signals. Conversely, if the second priority value PV2 is not greater than the first priority value PV1 (which may indicate that transmission of the wireless signals is currently more important than reception of the satellite signals), then processor 210 may not decrease (or alternatively may increase) the transmission rate and/or the power level of the wireless signals. In this manner, processor 210 may facilitate the transmission of the wireless signals when the interference with satellite signals is deemed to be acceptable.

For at least one embodiment, if processor 210 determines that the second priority value PV2 is greater than a priority threshold value, then processor 210 may terminate transmission of the wireless signals. Thereafter, if processor 210 determines that the second priority value PV2 becomes less than or equal to the priority threshold value, then processor 210 may resume transmission of the wireless signals.

Processor 210 may monitor (continuously or intermittingly) one or more operational parameters associated with the transmission of the wireless signals and/or with the reception of the satellite signals (612), and then dynamically update or adjust the first priority value PV1 and/or the second priority value PV2 in response to the operational parameters (614). In this manner, processor 210 may dynamically adjust or update the first priority value PV1 and/or the second priority value PV2 to reflect changes in the importance of transmitting the wireless signals relative to the importance of reception of satellite signals. In some embodiments, processor 210 may adjust the first priority value PV1 and/or the second priority value PV2 as follows:

If device 200 is in motion, then processor 210 may increase the second priority value PV2 and/or decrease the first priority value PV1 (e.g., because the importance of receiving satellite signals for positioning and/or navigation may increase when device 200 is moving). Conversely, if device 200 is stationary, then processor 210 may decrease the second priority value PV2 and/or increase the first priority value PV1 (e.g., because the importance of receiving satellite signals for positioning and/or navigation may decrease when device 200 is not moving, and/or wireless signals such as Wi-Fi signals may be more readily available when device 200 is stationary).

If the signal strength of the satellite signals falls below a signal strength threshold value, then processor 210 may increase the second priority value PV2 and/or decrease the first priority value PV1 (e.g., because as the signal strength of the satellite signals decreases, the satellite signals may be more prone to interference). Conversely, if the signal strength of the satellite signals is at or above the signal strength threshold value, then processor 210 may decrease the second priority value PV2 and/or increase the first priority value PV1 (e.g., because as the signal strength of the satellite signals increases, the satellite signals may be less prone to interference).

If device 200 is currently executing a satellite-based positioning application, then processor 210 may increase the second priority value PV2 and/or decrease the first priority value PV1 (e.g., because use of the satellite-based positioning application may indicate increased importance of receiving the satellite signals). Conversely, if device 200 is not currently executing the satellite-based positioning application, then processor 210 may decrease the second priority value PV2 and/or increase the first priority value PV1 (e.g., because device 200 may not be using the satellite signals).

If device 200 is currently executing a WLAN-based positioning application, then processor 210 may increase the first priority value PV1 and/or decrease the second priority value PV2 (e.g., because use of the WLAN-based positioning application may indicate less importance of receiving the satellite signals). Conversely, if device 200 is not currently executing the WLAN-based positioning application, then processor 210 may decrease the first priority value PV1 and/or increase the second priority value PV2 (e.g., because device 200 may not be using the Wi-Fi signals).

If processor 210 determines that the most recent wireless signal transmission occurred within a threshold time period ago, then processor 210 may increase the second priority value PV2 and/or decrease the first priority value PV1 (e.g., because device 200 recently completed transmission of one or more wireless data frames or packets). Conversely, if processor 210 determines that the most recent wireless signal transmission occurred more than the threshold time period ago, then processor 210 may decrease the second priority value PV2 and/or increase the first priority value PV1 (e.g., because device 200 has not recently completed transmission of one or more wireless data frames or packets). For at least one embodiment, the first priority value PV1 may be proportional to a first time value T_{Wi-Fi}, where T_{Wi-Fi} is the time elapsed since the last WLAN transmission. For the at least one embodiment, the second priority value PV2 may be proportional to a second time value T_{SAT}, where T_{SAT} is the time elapsed since the latest reception of satellite signals.

If processor 210 determines that a current WLAN traffic flow is associated with a “best-efforts” QoS indication (or other suitable low priority WLAN traffic), then processor 210 may increase the second priority value PV2 and/or decrease the first priority value PV1 (e.g., because the transmission of the WLAN traffic may be completed later using “best efforts”). Conversely, if processor 210 determines that the current WLAN traffic flow is associated with a “guaranteed bandwidth” QoS indication (or other suitable high priority WLAN traffic), then processor 210 may decrease the second priority value PV2 and/or increase the first priority value PV1 (e.g., because the transmission of the WLAN traffic is to completed according to the guaranteed bandwidth provisioning).

If processor 210 determines that the current WLAN throughput is greater than or equal to a throughput threshold value, then processor 210 may increase the second priority value PV2 and/or decrease the first priority value PV1 (e.g., because the WLAN throughput is acceptable). Conversely, processor 210 determines that the current WLAN throughput is less than the throughput threshold value, then processor 210 may decrease the second priority value PV2 and/or increase the first priority value PV1 (e.g., because the WLAN throughput is not acceptable). For at least one embodiment, the first priority value PV1 may be proportional to a value 1/TPUT, where TPUT is a measure of the WLAN throughput. For the at least one embodiment, the value of TPUT may be a normalized data rate metric such as B/(T×h×s), where B indicates the number of bits sent over the air, T is a certain amount of time, h is the spectral efficiency in bits per tone, and s is the number of spatial streams.

In addition, for some embodiments, processor 210 may dynamically adjust the first priority value PV1 and/or the second priority value PV2 in response to one or more weighting values provided by the user of device 200 (616). More specifically, the user may provide the weighting values to device 200 via user interface 230, and in response thereto, processor 210 may assign weighting values to the first priority value PV1 and/or to the second priority value PV2. In this manner, processor 210 may consider the user's preferences (e.g., whether the user deems transmission of the wireless signals to be more or less importance than reception of satellite signals) when assigning and/or adjusting the first and second priority values PV1 and PV2.

In addition, the processor 210 may dynamically adjust the first priority value PV1 and/or the second priority value PV2 in response to a combination of any number of the aforementioned operational parameters (e.g., information indicating whether the device is in motion, whether the device is currently using a satellite-based positioning application and/or a WLAN-based positioning application, the signal strength of the satellite signals, a length of time since the last WLAN transmission, a quality of service (QoS) parameter associated with WLAN traffic, WLAN throughput, and so on). For example, a weighted checksum algorithm may be used to determine how to dynamically adjust PV1 and PV2, wherein in some embodiments the weights may be determined by the user or preset by the manufacturer before use.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of operating a device to transmit wireless signals when satellite signals may be received, the method comprising:
assigning a first priority value to the wireless signals;
assigning a second priority value to the satellite signals;
comparing the first priority value and the second priority value; and
adjusting a transmission rate of the wireless signals in response to the comparing.

2. The method of claim 1, further comprising:
monitoring one or more operational parameters associated with the wireless signals; and
dynamically adjusting one or both of the first and second priority values in response to the monitoring.

3. The method of claim 1, wherein the wireless signals comprise Wi-Fi signals.

4. The method of claim 3, wherein the transmission rate is adjusted by modifying a number of transmission time slots allocated to the Wi-Fi signals.

5. The method of claim 3, wherein the transmission rate is adjusted by modifying a duration of one or more transmission time slots allocated to the Wi-Fi signals.

6. The method of claim 1, wherein the adjusting comprises:
decreasing the transmission rate of the wireless signals if the comparing indicates that the satellite signals have a higher priority than the wireless signals; and
increasing the transmission rate of the wireless signals if the comparing indicates that the satellite signals have a lower priority than the wireless signals.

7. The method of claim 1, wherein the adjusting further comprises:
terminating transmission of the wireless signals if the second priority value is greater than a threshold value.

8. The method of claim 1, further comprising:
filtering a portion of the received satellite signals during wireless signal transmissions if the transmission rate of the wireless signals is less than a threshold value.

9. The method of claim 1, further comprising:
filtering a portion of the received satellite signals during wireless signal transmissions if a duration of the wireless signal transmissions is less than a predetermined time period.

10. The method of claim 1, further comprising:
determining whether the device is in motion; and
dynamically adjusting the second priority value, relative to the first priority value, in response to the determining.

11. The method of claim 10, wherein the dynamically adjusting comprises:
increasing the second priority value relative to the first priority value if the device is in motion; and
decreasing the second priority value relative to the first priority value if the device is stationary.

12. The method of claim 1, further comprising:
determining whether the device is executing a WLAN-based positioning application; and
decreasing the second priority value relative to the first priority value if the device is executing the WLAN-based positioning application.

13. The method of claim 1, further comprising:
determining whether the wireless signals are associated with a guaranteed bandwidth data transmission; and
decreasing the second priority value relative to the first priority value if the wireless signals are associated with the guaranteed bandwidth data transmission.

14. The method of claim 1, further comprising:
determining whether a most recent transmission of the wireless signals occurred more than a predetermined time period ago; and
decreasing the second priority value relative to the first priority value if the most recent transmission of the wireless signals occurred more than the predetermined time period ago.

15. The method of claim 1, further comprising:
receiving a number of weighting values provided by a user of the device; and
adjusting the first priority value or the second priority value in response to the weighting values.

16. A wireless device, comprising:
a first circuit to transmit wireless signals;
a second circuit to receive satellite signals; and
a processor, coupled to the first circuit and the second circuit, to selectively adjust a transmission rate of the wireless signals in response to a comparison between a first priority value assigned to the wireless signals and a second priority value assigned to the satellite signals.

17. The wireless device of claim 16, wherein the processor is to further:
monitor one or more operational parameters associated with the wireless signals; and
dynamically adjust one or both of the first and second priority values in response to the monitoring.

18. The wireless device of claim 16, wherein the processor is to modify a number of transmission time slots allocated to the first circuit in response to the comparison.

19. The wireless device of claim 16, wherein the processor is to modify a duration of one or more transmission time slots allocated to the first circuit in response to the comparison.

20. The wireless device of claim 16, further comprising:
a memory, coupled to the processor, to store a number of weighting values provided by a user of the wireless device, wherein the processor is to adjust the first priority value or the second priority value in response to the weighting values.

21. The wireless device of claim 16, wherein the processor is to:
decrease the transmission rate of the wireless signals if the second priority value is greater than the first priority value.

22. The wireless device of claim 16, wherein the processor is to:
terminate transmission of the wireless signals if the second priority value is greater than a threshold value.

23. The wireless device of claim 16, wherein the processor is to:
filter a portion of the received satellite signals during wireless signal transmissions if the transmission rate of the wireless signals is less than a threshold value.

24. The wireless device of claim 16, wherein the processor is to:
filter a portion of the received satellite signals during wireless signal transmissions if a duration of the wireless signal transmissions is less than a predetermined time period.

25. The wireless device of claim 16, wherein the processor is to:
increase the second priority value, relative to the first priority value, if the device is in motion.

26. The wireless device of claim 16, wherein the processor is to:
decrease the second priority value, relative to the first priority value, if the device is executing a WLAN-based positioning application.

27. The wireless device of claim 16, wherein the processor is to:
decrease the second priority value, relative to the first priority value, if the wireless signals are associated with a guaranteed bandwidth data transmission.

28. The wireless device of claim 16, wherein the processor is to:
decrease the second priority value, relative to the first priority value, if a most recent transmission of the wireless signals occurred more than a predetermined time period ago.

29. A computer-readable storage medium containing program instructions that, when executed by a processor of a wireless device, cause the wireless device to:
assign a first priority value to the wireless signals;
assign a second priority value to the satellite signals;
compare the first priority value and the second priority value; and
selectively adjust a transmission rate of the wireless signals in response to the comparing.

30. The computer-readable storage medium of claim 29, wherein execution of the program instructions further cause the wireless device to:
monitor one or more operational parameters associated with the wireless signals; and
dynamically adjust one or both of the first and second priority values in response to the monitoring.

31. The computer-readable storage medium of claim 29, wherein the transmission rate is adjusted by modifying a number of transmission time slots allocated to the wireless signals.

32. The computer-readable storage medium of claim 29, wherein the wireless device is to selectively adjust the transmission rate by:
decreasing the transmission rate of the wireless signals if the second priority value is greater than the first priority value.

33. The computer-readable storage medium of claim 29, wherein execution of the program instructions further cause the wireless device to:
terminate transmission of the wireless signals if the second priority value is greater than a threshold value.

34. The computer-readable storage medium of claim 29, wherein execution of the program instructions cause the wireless device to:
increase the second priority value relative to the first priority value if the device is in motion.

35. The computer-readable storage medium of claim 29, wherein execution of the program instructions cause the wireless device to:
decrease the second priority value relative to the first priority value if the device is executing a WLAN-based positioning application.

36. The computer-readable storage medium of claim 29, wherein execution of the program instructions cause the wireless device to:
decrease the second priority value relative to the first priority value if the wireless signals are associated with a guaranteed bandwidth data transmission.

37. The computer-readable storage medium of claim 29, wherein execution of the program instructions cause the wireless device to:
decrease the second priority value relative to the first priority value if a most recent transmission of the Wi-Fi signals occurred more than a predetermined time period ago.

38. The computer-readable storage medium of claim 29, wherein execution of the program instructions further cause the wireless device to:
receive a number of weighting values provided by a user of the device; and
dynamically adjust the first priority value or the second priority value in response to the weighting values.

39. A wireless device to transmit wireless signals when satellite signals may be received, the wireless device comprising:
means for assigning a first priority value to the wireless signals;
means for assigning a second priority value to the satellite signals;
means for comparing the first priority value and the second priority value; and
means for selectively adjusting a transmission rate of the wireless signals in response to the comparing.

40. The wireless device of claim 39, further comprising:
means for monitoring one or more operational parameters associated with the wireless signals; and
means for dynamically adjusting one or both of the first and second priority values in response to the monitoring.

41. The wireless device of claim 39, further comprising:
means for terminating transmission of the wireless signals if the second priority value is greater than a threshold value.

42. The wireless device of claim 39, further comprising:
means for determining whether the device is in motion; and
means for dynamically adjusting the second priority value, relative to the first priority value, in response to the determining.

43. The wireless device of claim 39, further comprising:
means for determining whether the device is executing a WLAN-based positioning application; and
means for dynamically adjusting the second priority value, relative to the first priority value, in response to the determining.

44. The wireless device of claim 39, further comprising:
means for determining whether the wireless signals are associated with a guaranteed bandwidth data transmission; and
means for dynamically adjusting the second priority value, relative to the first priority value, in response to the determining.

45. The wireless device of claim 39, further comprising:
means for determining whether a most recent transmission of the wireless signals occurred more than a predetermined time period ago; and
means for dynamically adjusting the second priority value, relative to the first priority value, in response to the determining.

46. The wireless device of claim 39, further comprising:
means for receiving a number of weighting values provided by a user of the device; and
means for dynamically adjusting the first priority value or the second priority value in response to the weighting values.
